(19) United States
(12) Patent Application Publication
(10) Pub. No.: US 2007/0223057 A1
(43) Pub. Date: Sep. 27, 2007

(54) Method of estimating noise in spatial filtering of images

(75) Inventor: Alexander Berestov, San Jose, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 11/386,230

(22) Filed: Mar. 21, 2006

(51) Int. Cl. H04N 1/38

(52) U.S. Cl. 358/463

(57) ABSTRACT

A noise prediction scheme provides a method of predicting an output noise variance resulting from a spatial filtering transformation. For a given input image signal with a known input noise variance, a periodic model is developed. The periodic model defines periodic boundary conditions for the input image signal based on the principal that the input image signal is repeated in each direction. In this manner, pixel values are defined about either side of the input image signal boundaries in either one, two, or three dimensions. A spatial filtering transformation includes convoluting the input image signal with an impulse response of a filter. Autocavariances at different points in time or lags of the input image signal are also determined. The number of autocovariances is determined by the nature of the spatial filtering transformation. The noise prediction scheme predicts an output noise variance resulting from the spatial filtering transformation based on the input noise variance, the autocovariances, and the periodic boundary conditions of the input image signal.

### FIELD OF THE INVENTION

The present invention relates to the field of video processing and noise transformations. More particularly, the present invention relates to the field of error analysis for spatial transformation modeling using filters.

### BACKGROUND OF THE INVENTION

Image data transformation is performed as part of an image processing system. Transformations generally include linear transformations, non-linear transformations, and spatial transformations. Application of image data transformations must account for noise propagation through the image processing system. The Burns and Berns method provides a mechanism for propagating noise variance through linear and non-linear image transformations. However, their work did not address the problem of propagating noise variance through spatial transformations.

Spatial transformations alter the spatial relationships between pixels in an image by mapping locations in an input image to new locations in an output image. Common transformational operations include resizing, rotating, and interactive cropping of images, as well as geometric transformations with arbitrary dimensional arrays. Spatial operations include, but are not limited to demosiacing, edge enhancement or sharpening, and filtering.

Image filtering enables reduction of the noise present in the image, sharpening or blurring of the image, or performing feature detection. Many types of spatial filtering operations are available including arithmetic mean, geometric mean, harmonic mean, and median filters.

### SUMMARY OF THE INVENTION

A noise prediction scheme provides a method of predicting an output noise variance resulting from spatial filtering and edge enhancement transformations. An image capturing system is designed according to the predictions of the noise prediction scheme. For a given input image signal with a known input noise variance, a periodic model is developed. The periodic model defines periodic boundary conditions for the input image signal by essentially repeating the input image signal in each direction. In this manner, pixel values are defined about either side of the input image signal boundaries in either one, two, or three dimensions. A spatial filtering or edge enhancement transformation is defined with a known impulse response. In one embodiment, the spatial filtering or edge enhancement transformation includes convoluting the input image signal with an impulse response of a filter. Autocovariances at different lags of the input image signal are also determined. There are multiple autocovariances, the number of which is determined by the nature of the spatial filtering or edge enhancement transformation. The noise prediction scheme predicts an output noise variance resulting from the spatial filtering or edge enhancement transformation based on the input noise variance, the autocovariances, and the periodic boundary conditions of the input image signal.

In one aspect, a method of predicting an output noise variance is described. The method includes obtaining an input image signal, wherein the input image signal includes a corresponding input noise having an input noise variance, defining a periodic model associated with the input image signal, wherein the periodic model defines periodic boundary conditions for the input image signal, defining a spatial filtering transformation based on a filter having an impulse response, determining autocovariances at different lags of the input image signal, and determining an output noise variance associated with the input image signal according to the input noise variance, the impulse response of the filter, the autocovariances, and the periodic boundary conditions of the input image signal. The spatial filtering transformations can include convoluting the input image signal with the impulse response of the filter. The input image signal can correspond to an image X comprising a I×J lattice of pixels x(i,j), further wherein the periodic boundary conditions define x(i±I, j±J)=x(i,j). Defining the spatial filtering transformation can include applying a filter mask to the input image signal. The filter mask can comprise a M×N rectangular filter mask. A number of autocovariances can determined by 2MN−(M+N).

In another aspect, a method of predicting noise propagation after performing a spatial transformation operation is described. The method includes obtaining an input image signal, wherein the input image signal includes a corresponding input noise having an input noise variance, defining a periodic model associated with the input image signal, wherein the periodic model defines periodic boundary conditions for the input image signal, defining a spatial transformation operation according to a convolution of the input image signal, determining autocovariances at different lags of the input image signal, and determining an output noise variance according to the input noise variance, the autocovariances, and the periodic boundary conditions of the input image signal. The spatial transformation operation can comprise a non-linear filtering operation. The spatial transformation operation can comprise a sharpening operation. The spatial transformation operation can comprise a linear filtering operation. The spatial filtering transformation can include convoluting the input image signal with an impulse response of a filter.

In yet another aspect, a computer readable medium including program instructions for execution on a controller coupled to an image capturing system is described. The computer readable medium, which when executed by the controller, causes the image capturing system to perform obtaining an input image signal, wherein the input image signal includes a corresponding input noise having an input noise variance, defining a periodic model associated with the input image signal, wherein the periodic model defines periodic boundary conditions for the input image signal, defining a spatial filtering transformation based on a filter having an impulse response, determining autocovariances at different lags of the input image signal, and determining an output noise variance associated with the input image signal according to the input noise variance, the impulse response of the filter, the autocovariances, and the periodic boundary conditions of the input image signal. The spatial filtering transformations can include convoluting the input image signal with the impulse response of the filter. The input image signal can correspond to an image X comprising a I×J lattice of pixels x(i,j), further wherein the periodic boundary conditions define x(i±I, j±J)=x(i,j). Defining the spatial filtering transformation can include applying a filter mask to the input image signal. The filter mask can comprise a M×N rectangular filter mask. A number of autocovariances can be determined by 2MN−(M+N).

In still yet another aspect, an image capturing system is described. The image capturing system includes an image sensing module to detect an input image signal, wherein the input image signal includes a corresponding input noise having an input noise variance, and a processing module coupled to the image sensing module, wherein the processing module is configured to define a periodic model associated with the input image signal, wherein the periodic model defines periodic boundary conditions for the input image signal, to define a spatial filtering transformation based on a filter having an impulse response, to determine autocovariances at different lags of the input image signal, and to determine an output noise variance associated with the input image signal according to the input noise variance, the impulse response of the filter, the autocovariances, and the periodic boundary conditions of the input image signal. The image capturing can also include imaging optics to receive input light from an image, to filter the received input light to form the input image signal, and to provide the input image signal to the image sensing module. The spatial filtering transformations include convoluting the input image signal with the impulse response of the filter. The input image signal can correspond to an image X comprising a I×J lattice of pixels x(i,j), further wherein the periodic boundary conditions define x(i±I, j±J)=x(i,j). The processing module can be configured to define the spatial filtering transformation by applying a filter mask to the input image signal. The filter mask comprises a M×N rectangular filter mask. A number of autocovariances can be determined by 2MN−(M+N).

### BRIEF DESCRIPTION OF THE DRAWINGS

FIG. 1 illustrates an exemplary lattice for a given image.

FIG. 2 illustrates a one-dimensional periodic model for the image.

FIG. 3 illustrates a two-dimensional periodic model for the image.

FIG. 4 illustrates the autocovariance function gₓₓ(0,1) between the image X1 and the shifted image X2.

FIG. 5 illustrates a periodic model applied to a one-dimensional finite difference grid.

FIG. 6 illustrates a filter applied to the pixel x(i) of the one-dimensional finite difference grid of FIG. 5.

FIG. 7 illustrates the filter applied to the boundary pixel x0 of the one-dimensional finite difference grid of FIG. 5.

FIG. 8 illustrates periodic boundary conditions applied to a two-dimensional finite difference grid.

FIG. 9 illustrates an impulse response of a 3×3 filter.

FIG. 10 illustrates a method of predicting an output noise variance resulting from a spatial filtering transformation.

FIG. 11 illustrates a block diagram of an exemplary image capturing system configured to operate according to the noise predicting methodology.

Embodiments of the noise prediction models are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

Generating an output noise model to predict the output noise variance is integral to designing an image capturing device. For a given input noise variance, predicting the impact of spatial filtering on the input noise variance provides a component of the output noise model.

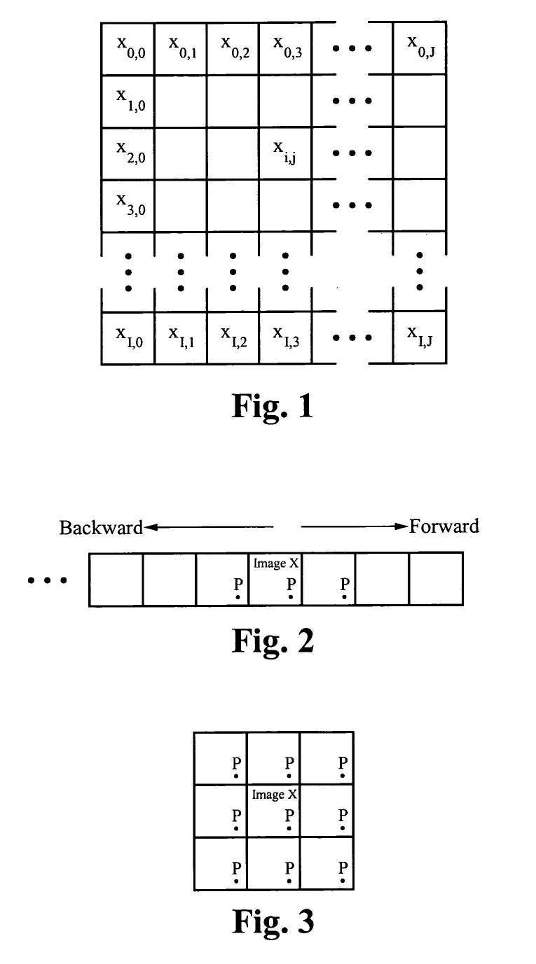

In general, an image is composed of a number of pixel elements arranged in a lattice, also referred to as a finite difference grid. FIG. 1 illustrates an exemplary lattice for a given image X. Each pixel x(i,j) within the image X is designated by its row position and column position within the lattice, where the size of the lattice is I×J. An image capturing device measures the signals at each pixel, and as such, each measured pixel is a discrete point, not a continuous coverage of the image space. At each pixel point, the signal is considered independently. By considering each pixel point within the image, an output for the entire image is determined.

Linear spatial filtering is based on two-dimensional convolution of the pixel elements x(i,j) with the impulse response of a filter h(i,j). For every pixel within the image, the two-dimensional convolution is a weighted sum of the pixel x(i,j), its neighboring pixels, and the weights defined by the impulse response of the filter h(i,j). It is a common practice to refer to the impulse of the filter as a filter mask. For example, for an M×N filter with the impulse response given by the weights A_{m,n} (M and N are odd numbers), spatial convolution gives:

$$y ( i , j ) = {\sum }_{m = 0}^{M - 1} {\sum }_{n = 0}^{N - 1} x ( i - \frac{M - 1}{2} + m , j - \frac{N - 1}{2} + n ) {A}_{m , n} . \qquad ( 1 )$$

The concept of spatial filtering using a filter mask can be expanded to any size or shape desired, but usually rectangular shaped masks of odd sizes are used.

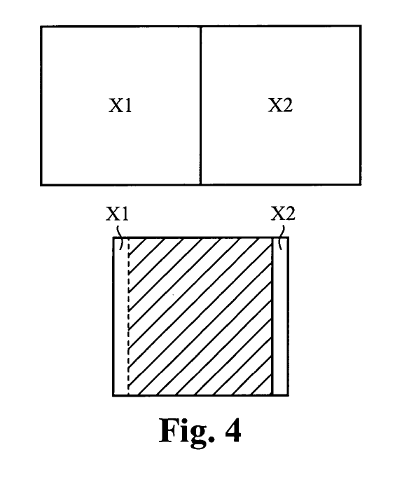

The above spatial filtering technique works smoothly when applied to pixels in the interior of the image. However, complications arise when applied at or near the borders of the image because beyond the border there are no pixels to be used in the convolution. To overcome this limitation, periodic modeling is applied to the spatial filtering technique. Using periodic modeling, for any given image, the image is repeated in all directions. Consider a one-dimensional case. FIG. 2 illustrates a one-dimensional periodic model for the image X. In this one-dimensional model, a given image X is repeated in both the forward and backward direction such that a given point P is the same in each image. In other words, a duplicate image of image X is positioned at both the forward edge and the backward edge of the image X. In this manner, the left most edge of a duplicate image X is positioned against the right most edge of the original image X. Similarly, the right most edge of a duplicate image X is positioned against the left most edge of the original image X. The two-dimensional case configures a duplicate image X in each two-dimensional direction from the original image X. FIG. 3 illustrates a two-dimensional periodic model for the image X. The given point P is the same in each image. Periodic modeling enables the use of periodic boundary conditions, as described in greater detail below.

To understand how spatial transformations modify image noise, statistical properties of the spatially filtered image are expressed in terms of the known properties of the original image, such as the mean, noise variance, and autocovariance. The variance of a random variable is a measure of its statistical dispersion, indicating how far from the expected value its values typically are. The variance of random variable ‘x’ is typically designated as r²ₓ. Autocovariance is a mathematical tool used frequently in signal processing for analyzing functions or series of values, such as time domain signals. Autocovariance is the cross-correlation of a signal with itself. The following equations (1), (2), and (3) correspond to the mean, variance, and autocovariance functions, respectively, for a given image X of size I×J. The image X consists of x(i,j) pixels.

$$\begin{matrix}{u}_{x} = \frac{1}{IJ} {\sum }_{i = 0}^{I - 1} {\sum }_{j = 0}^{J - 1} {x}_{i , j} , & ( 2 ) \\ {r}_{x}^{2} = \frac{1}{IJ} {\sum }_{i = 0}^{I - 1} {\sum }_{j = 0}^{J - 1} {( {x}_{i , j} - {u}_{x} )}^{2} , & ( 3 ) \\ {g}_{xx} ( k , l ) = \frac{1}{IJ} {\sum }_{i = 0}^{I - 1} {\sum }_{j = 0}^{J - 1} ( {x}_{i , j} - {u}_{x} ) ( {x}_{i + k , j + l} - {u}_{x} ) . & ( 4 )\end{matrix}$$

The autocovariance function provides a comparison between the image and a shifted version of the image. For example, if images X1 and X2 are the same, an autocovariance of gₓₓ(0,0) means that there is no shift between the two images X1 and X2. For an autocovariance of gₓₓ(0,1), the image X2 is shifted by one pixel to the right compared to the image X1. FIG. 4 illustrates the autocovariance function gₓₓ(0,1) between the image X1 and the image X2. As can be seen in FIG. 4, the image X2 is shifted by one pixel to the right compared to the image X1.

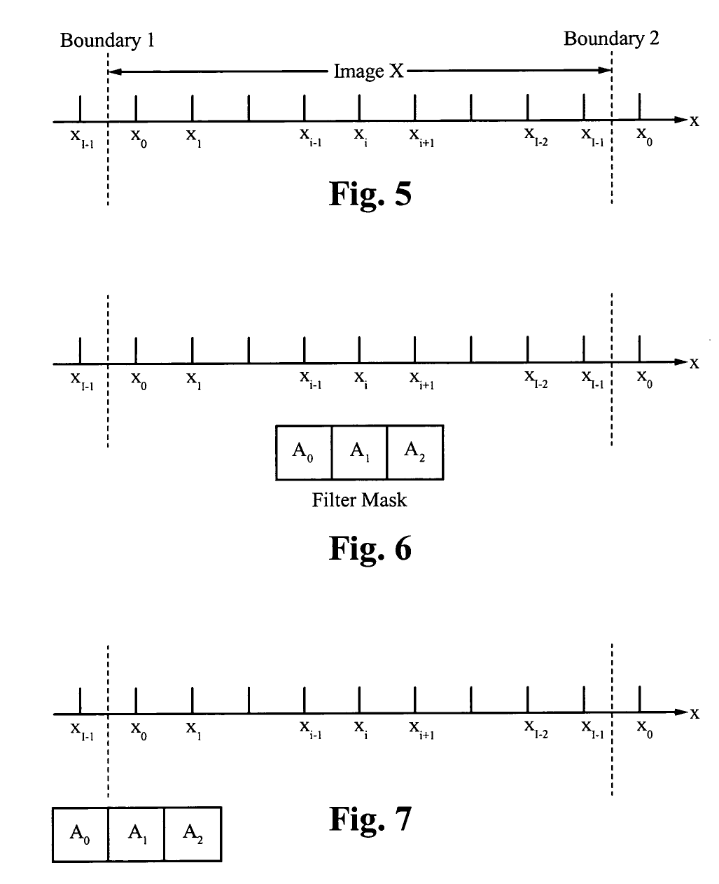

A first spatial transformation is applied to a one-dimensional signal, which is defined on a finite difference grid illustrated in FIG. 5. The finite difference grid in FIG. 5 corresponds to an image X that includes I, x(i) pixels. The periodic model is applied to image X such that at the boundary 1, a right most edge of a duplicate image X is aligned with a left most edge of the original image X. At the boundary 1, a periodic boundary condition is established where a pixel x_{I-1} of the duplicate image X is positioned adjacent a pixel x0 of the original image X. At the boundary 2, a left most edge of another duplicate image X is aligned with a right most edge of the original image X such that another periodic boundary condition is established where a pixel x₀ of the duplicate image X is positioned adjacent a pixel x₁₋₁ of the original image X. In general, the one-dimensional periodic boundary conditions are summarized as x(i±I)=x(i).

Spatial filters usually can be represented with filter masks. Therefore, to perform the desired spatial transformation, a filter mask is used. As related to FIG. 5, a one-dimensional filter is applied to the one-dimensional signal corresponding to the one-dimensional image X. For discussion purposes, a filter of length 3 is used. Alternatively, a filter of any length can be used. The impulse response of the filter is given by the weights Aₘ, m=0, 1, 2. The filter is applied to each of the pixels x(i). FIG. 6 illustrates a filter applied to the pixel x(i) of the one-dimensional signal of FIG. 5. In this configuration, the weight A₀ of the impulse response is applied to pixel xᵢ₋₁, the weight A₁ is applied to pixel xᵢ, and the weight A₂ is applied to pixel xᵢ₊₁. FIG. 7 illustrates the filter applied to the boundary pixel x0 of the one-dimensional signal of FIG. 5. In this configuration, the weight A₀ of the impulse response is applied to pixel x_{I-1}, the weight A₁ is applied to pixel x₀, and the weight A₂ is applied to pixel x₁. The filter is applied similarly to each of the pixels in the image X utilizing the defined periodic boundary conditions. Taking the periodic model into account, the mean u_{y} of the filtered image Y, consisting of filtered pixels y(i), is written as:

$$\begin{matrix}{u}_{y} = \frac{1}{I} {\sum }_{i - 1}^{I} {y}_{i} \\ = \frac{1}{I} {\sum }_{i = 1}^{I} ( {A}_{0} {x}_{i - 1} + {A}_{1} {x}_{i} + {A}_{2} {x}_{i + 1} ) \\ = \frac{1}{I} {\sum }_{i = 1}^{I} ( {A}_{0} {x}_{i} + {A}_{1} {x}_{i} + {A}_{2} {x}_{i} )\end{matrix} \\ {u}_{y} = ( {A}_{0} + {A}_{1} + {A}_{2} ) {u}_{x} \qquad ( 5 )$$

The variance of the filtered image is written in terms of the original image statistics:

$$\begin{matrix}{r}_{ y}^{ 2} = \frac{1}{I} {\sum }_{i = 0}^{I - 1} {( {y}_{i} - {u}_{y} )}^{2} \\ = \frac{1}{I} {\sum }_{i = 0}^{I - 1} {( {A}_{0} {x}_{i - 1} + {A}_{1} {x}_{i} + {A}_{2} {x}_{i + 1} - {A}_{0} {u}_{y} + {A}_{1} {u}_{y} + {A}_{2} {u}_{y} )}^{2} \\ = \frac{1}{I} {\sum }_{i = 0}^{I - 1} {[ {A}_{0} ( {x}_{i - 1} - {u}_{y} ) + {A}_{1} ( {x}_{i} - {u}_{y} ) + {A}_{2} ( {x}_{i + 1} - {u}_{y} ) ]}^{2} \\ = \frac{1}{I} {\sum }_{i = 0}^{I - 1} [ {{A}_{0}^{2} ( {x}_{i - 1} - {u}_{y} )}^{2} + {{A}_{1}^{2} ( {x}_{i} - {u}_{y} )}^{2} + {{A}_{2}^{2} ( {x}_{i + 1} - {u}_{y} )}^{2} ] + \\ \frac{1}{I} {\sum }_{i = 0}^{I - 1} [ 2 {A}_{0} {A}_{1} ( {x}_{i - 1} - {u}_{y} ) ( {x}_{i} - {u}_{y} ) + \\ 2 {A}_{ 0} {A}_{ 2} ( {x}_{ i - 1} - {u}_{ y} ) ( {x}_{i + 1} - {u}_{y} ) + 2 {A}_{1} {A}_{2} ( {x}_{i} - {u}_{y } ) ( {x}_{i + 1} + {u}_{y} ) ] .\end{matrix}$$

Taking into account periodic boundary conditions, the variance of the output signal becomes:
r_{y}²=(A₀²+A₁²+A₂²)rₓ²+2(A₀A₁+A₁A₂)gₓₓ(1)+2A₀A₂gₓₓ(2). (6)

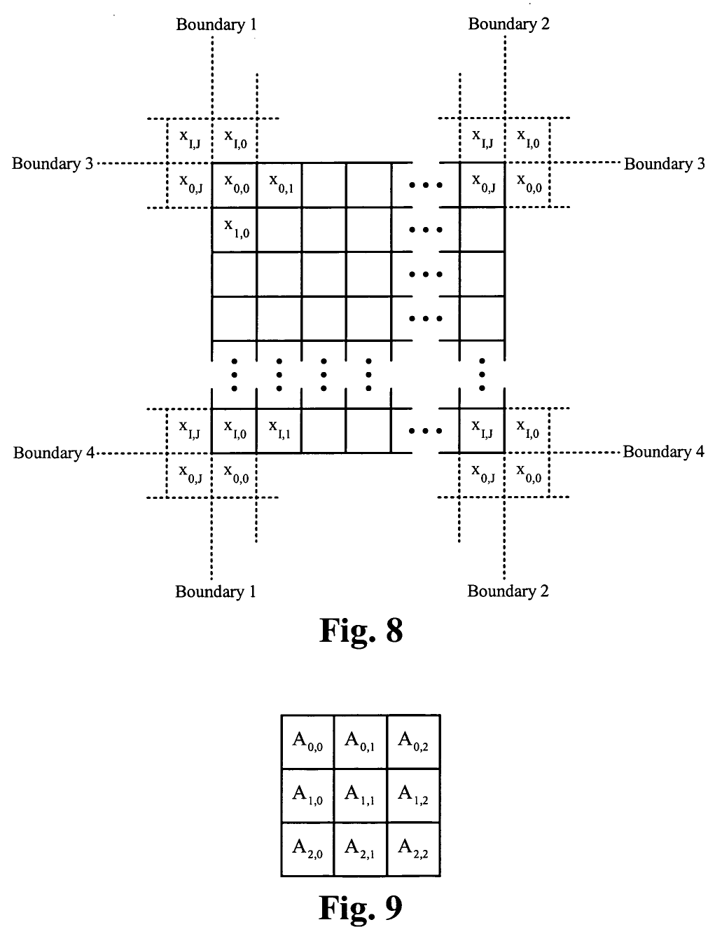

A second spatial transformation is applied to a two-dimensional signal, which is defined on a finite difference grid as illustrated in FIG. 1. FIG. 8 illustrates periodic boundary conditions applied to the two-dimensional signal. The periodic model is applied to the two-dimensional signal in a manner similar to the one dimensional signal as described in relation to FIG. 5 and the two-dimensional periodic model of FIG. 3. The finite difference grid in FIG. 8 corresponds to an image X that includes I×J, x(i,j) pixels. The periodic model is applied to image X such that at the boundary 1, a right most edge of a duplicate image X is aligned with a left most edge of the original image X. At the boundary 1, a periodic boundary condition is established where for example a pixel x_{0,j} of the duplicate image X is positioned adjacent a pixel x_{0,0} of the original image X. At the boundary 2, a left most edge of another duplicate image X is aligned with a right most edge of the original image X such that another periodic boundary condition is established where a pixel x_{0,0} of the duplicate image X is positioned adjacent a pixel x_{0,j} of the original image X. At the boundary 3, a bottom most edge of a duplicate image X is aligned with a top most edge of the original image X such that a periodic boundary condition is established where for example a pixel x_{1,0} of the duplicate image X is positioned adjacent the pixel x_{0,0} of the original image X. At the boundary 4, a top most edge of another duplicate image X is aligned with a bottom most edge of the original image X such that another periodic boundary condition is established where for example a pixel x_{0,0} of the duplicate image X is positioned adjacent a pixel x_{1,0} of the original image X. A duplicate image X is also adjacently positioned at a diagonal to each corner pixel of the original image X such that additional periodic boundary conditions are established. For example, at the boundary 2 and the boundary 3, a duplicate image X is diagonally positioned such that a pixel x_{1,0} of the duplicate image X is positioned diagonally adjacent a pixel x_{0,j} of the original image X. In general, the two-dimensional periodic boundary conditions are summarized as x(i±I, j±J))=x(i,j).

A two-dimensional filter is applied to the two-dimensional signal corresponding to the image X. For discussion purposes, a 3×3 filter is used. Alternatively, a M×N filter can be used. Still alternatively, a non-rectangular filter of any dimension can be used The impulse response of the 3×3 filter is given by the weights A_{m,n,} m=0, 1, 2 and n=0, 1, 2. The filter is applied to each of the pixels x(i,j). FIG. 9 illustrates an impulse response of a 3×3 filter. The filter in FIG. 9 is applied to each of the pixels in the image X of FIG. 8 utilizing the defined periodic boundary conditions. Taking the two-dimensional periodic model into account, the mean u_{y} of the filtered image Y, consisting of filtered pixels y(i,j) and filtered with M×N filter with the impulse response given be the weights A_{m,n,} is written as:

$${u}_{y} = \frac{1}{IJ} {\sum }_{i = 0}^{I - 1} {\sum }_{j = 0}^{J - 1} {\sum }_{m = 0}^{M - 1} {\sum }_{n = 0}^{N - 1} x ( i - \frac{M - 1}{2} + m , j - \frac{N - 1}{2} + n ) {A}_{m , n} \qquad ( 7 )$$

Taking the periodic model into account, where x(i±I, j±J))=x(i,j), equation (7) is rewritten as:

$${u}_{y} = \frac{1}{IJ} {\sum }_{m = 0}^{M - 1} {\sum }_{n = 0}^{N - 1} {\sum }_{i = 0}^{I - 1} {\sum }_{j = 0}^{J - 1} x ( i , j ) {A}_{m , n} = {u}_{x} {\sum }_{m = 0}^{M - 1} {\sum }_{n = 0}^{N - 1} {A}_{m , n} \qquad ( 8 )$$

The variance of the filtered image is written in terms of the original image as:

$$\begin{matrix}{r}_{y}^{2} = \frac{1}{IJ} {\sum }_{i = 0}^{I - 1} {\sum }_{j = 0}^{J - 1} {( {y}_{i , j} - {u}_{y} )}^{2} \\ = \frac{1}{IJ} {\sum }_{i = 0}^{I - 1} {\sum }_{j = 0}^{J - 1} [ {\sum }_{m = 0}^{M - 1} {\sum }_{n = 0}^{N - 1} x ( i - \frac{M - 1}{2} + m , j - \\ { \frac{N - 1}{2} + n ) {A}_{m , n} - {u}_{x} {\sum }_{m = 0}^{M - 1} {\sum }_{n = 0}^{N - 1} {A}_{m , n} ]}^{2} \\ = \frac{1}{IJ} {\sum }_{i = 0}^{I - 1} {\sum }_{j = 0}^{J - 1} \{ {\sum }_{m = 0}^{M - 1} {\sum }_{n = 0}^{N - 1} {A}_{m , n} [ x ( i - \frac{M - 1}{2} + m , j - \\ { \frac{N - 1}{2} + n ) - {u}_{x} ] \}}^{2}\end{matrix}$$

Taking into account the periodic boundary conditions, the fact that autocovariances of the same interval along the same direction under the mask are equal, and that gₓₓ(−k,−1)=gₓₓ(k,1), the variance is rewritten as:

$$\begin{matrix}{r}_{y}^{2} = \frac{1}{IJ} {\sum }_{i = 0}^{I - 1} {\sum }_{j = 0}^{J - 1} {\sum }_{m = 0}^{M - 1} {\sum }_{n = 0}^{N - 1} {\sum }_{k = 0}^{M - 1} {\sum }_{l = 0}^{N - 1} {A}_{m , n} [ x ( i - \frac{M - 1}{2} + m , j - \\ \frac{N - 1}{2} + n ) - {u}_{x} ] {A}_{k , l} [ x ( i - \frac{M - 1}{2} + k , j - \frac{N - 1}{2} + l ) - {u}_{x} ] \\ = {r}_{x}^{2} {\sum }_{m = 0}^{M - 1} {\sum }_{n = 0}^{N - 1} {A}_{m , n}^{2} + 2 {\sum }_{k = 1}^{M - 1} {\sum }_{l = 0}^{N - 1} {g}_{xx} ( k , l ) {\sum }_{m = 0}^{M - 1 - k} {\sum }_{n = 0}^{N - 1 - l} {A}_{m , n} {A}_{m + k , n + l} + \\ 2 {\sum }_{k = 0}^{1 - M} {\sum }_{l = 1}^{N - 1} {g}_{xx} ( k , l ) {\sum }_{m = M - 1}^{- k} {\sum }_{n = 0}^{N - 1 - l} {A}_{m , n} {A}_{m + k , n + l}\end{matrix}$$

The number of autocovariances to be considered covers all possible intervals and directions under the filter mask and is equal to 2MN−(M+N). For a one-dimensional linear filter of length M, the number of autocovariances to be considered equals 2M−(M+1)=M−1. If the input noise is white and the image is flat (xᵢ=constant), all autocovariances are equal to zero since there is no periodicity in the signal. In this case, the output noise variance reduces to:

$${r}_{y}^{2} = {r}_{x}^{2} {\sum }_{m = 0}^{M - 1} {\sum }_{n = 0}^{N - 1} {A}_{m , n}^{2} .$$

These considerations are valid for any linear filter that can be represented with a rectangular filter mask. For example, the linear spatial filter with M×N=3×3, as shown in FIG. 9, produces the following noise transformation with 2MN−(M+N)=12 autocovariances:

$$\begin{matrix}{r}_{y}^{2} = {r}_{x}^{2} ( {A}_{0 , 0}^{2} + {A}_{0 , 1}^{2} + {A}_{0 , 2}^{2} + {A}_{1 , 0}^{2} + {A}_{1 , 1}^{2} + {A}_{1 , 2}^{2} + {A}_{2 , 0}^{2} + {A}_{2 , 1}^{2} + {A}_{2 , 2}^{2} ) + \\ 2 {g}_{xx} ( 1 , 0 ) ( {A}_{0 , 0} {A}_{1 , 0} + {A}_{0 , 1} {A}_{1 , 1} + {A}_{0 , 2} {A}_{1 , 2} + {A}_{1 , 0} {A}_{2 , 0} + \\ {A}_{1 , 1} {A}_{2 , 1} + {A}_{1 , 2} {A}_{2 , 2} ) + 2 {g}_{xx} ( 0 , 1 ) ( {A}_{2 , 0} {A}_{2 , 1} + {A}_{2 , 1} {A}_{2 , 2} + \\ {A}_{1 , 0} {A}_{1 , 1} + {A}_{1 , 1} {A}_{1 , 2} + {A}_{0 , 0} {A}_{0 , 1} + {A}_{0 , 1} {A}_{0 , 2} ) + 2 {g}_{xx} ( 1 , 1 ) \\ ( {A}_{0 , 0} {A}_{1 , 1} + {A}_{0 , 1} {A}_{1 , 2} + {A}_{1 , 0} {A}_{2 , 1} + {A}_{1 , 1} {A}_{2 , 2} ) + \\ 2 {g}_{xx} ( - 1 , 1 ) ( {A}_{2 , 0} {A}_{1 , 1} + {A}_{2 , 1} {A}_{1 , 2} + {A}_{1 , 0} {A}_{0 , 1} + {A}_{1 , 1} {A}_{0 , 2} ) + \\ 2 {g}_{xx} ( 2 , 0 ) ( {A}_{0 , 0} {A}_{2 , 0} + {A}_{0 , 1} {A}_{2 , 1} + {A}_{0 , 2} {A}_{2 , 2} ) + 2 {g}_{xx} ( 0 , 2 ) \\ ( {A}_{2 , 0} {A}_{2 , 2} + {A}_{1 , 0} {A}_{1 , 2} + {A}_{0 , 0} {A}_{0 , 2} ) + 2 {g}_{xx} ( 1 , 2 ) ( {A}_{0 , 0} {A}_{1 , 2} + \\ {A}_{1 , 0} {A}_{2 , 2} ) + 2 {g}_{xx} ( 2 , 1 ) ( {A}_{ 0 , 0} {A}_{ 2 , 1} + {A}_{ 0 , 1} {A}_{ 2 , 2} ) + 2 {g}_{xx} ( - 1 , 2 ) \\ ( {A}_{2 , 0} {A}_{1 , 2} + {A}_{1 , 0} {A}_{0 , 2} ) + 2 {g}_{xx} ( - 2 , 1 ) ( {A}_{2 , 0} {A}_{0 , 1} + {A}_{2 , 1} {A}_{0 , 2} ) + \\ 2 {g}_{xx} ( 2 , 2 ) ( {A}_{0 , 0} {A}_{2 , 2} ) + 2 {g}_{xx} ( - 2 , 2 ) ( {A}_{2 , 0} {A}_{0 , 2} ) .\end{matrix}$$

If during the spatial transformation the noise becomes spatially correlated, the autocovariances at different intervals and directions are considered to account for all noise energy. In this case, the number of autocovariances for the mask of the size M×N is equal to 2MN−(M+N).

The noise variance after filtering is expressed in terms of the input noise variance and the autocovariance function computed for a small number of shifts. In other words, the variance before filtering is noise dependent, while the variance after filtering depends not only on the input variance, but also on the autocovariance functions of the input image.

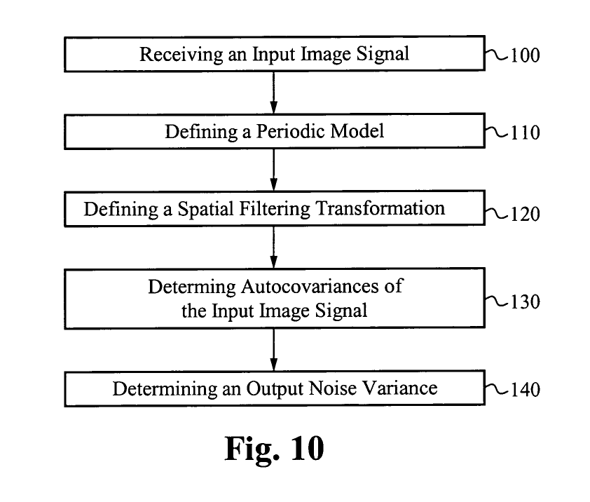

FIG. 10 illustrates a method of predicting an output noise variance resulting from a spatial filtering transformation. At the step 100, an input image signal is received. The input image signal includes a corresponding input noise having an input noise variance. At the step 110, a periodic model associated with the input image signal is defined. The periodic model defines periodic boundary conditions for the input image signal. In one embodiment, the input image signal represents an input image, and the periodic model defines a duplicate version of the input image at each of its boundaries. As such, the input image is repeated in one, two, or three dimensions. At the step 120, a spatial filtering transformation is defined based on a filter having an impulse response. In one embodiment, the spatial filtering transformation includes convoluting the input image signal with an impulse response of the filter. At the step 130, autocovariances at different points in time or lags of the input image signal are determined. The number of autocovariances is determined by the nature of the spatial filtering transformation. At the step 140, an output noise variance is predicted based on the input noise variance, the impulse response of the filter, the autocovariances, and the periodic boundary conditions of the input image signal.

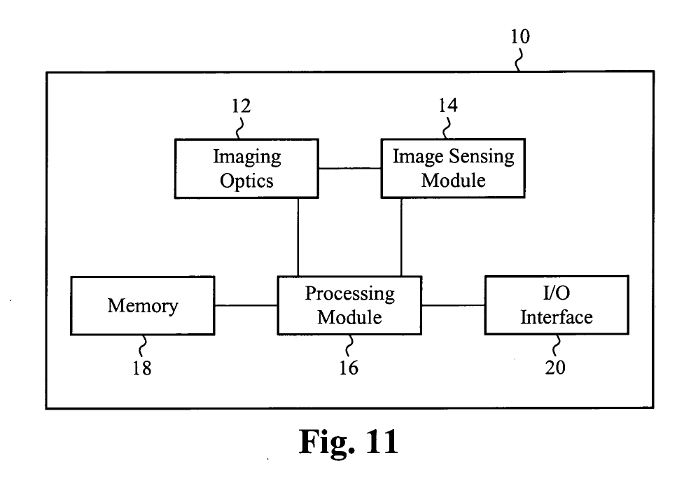

FIG. 11 illustrates a block diagram of an exemplary image capturing system 10 configured to operate according to the noise predicting methodology. The image capturing system 10 is any device capable of capturing an image or video sequence, such as a camera or a camcorder. The image capturing system 10 includes imaging optics 12, an image sensing module 14, a processing module 16, a memory 18, and an input/output (I/O) interface 20.

The imaging optics 12 include any conventional optics to receive an input light representative of an image to be captured, to filter the input light, and to direct the filtered light to the image sensing module 14. Alternatively, the imaging optics 12 do not filter the input light. The image sensing module 14 includes one or more sensing elements to detect the filtered light. Alternatively, the image sensing module 14 includes a color filter array to filter the input light and one or more sensing elements to detect the light filtered by the color filter array.

The memory 10 can include both fixed and removable media using any one or more of magnetic, optical or magneto-optical storage technology or any other available mass storage technology. The processing module 16 is configured to control the operation of the image capturing system 10. The processing module 16 is also configured to define the spatial filtering transformations and perform the output noise prediction methodology described above. The I/O interface 20 includes a user interface and a network interface. The user interface can include a display to show user instructions, feedback related to input user commands, and/or the images captured and processed by the imaging optics 12, the image sensing module 14, and the processing module 16. The network interface 20 includes a physical interface circuit for sending and receiving imaging data and control communications over a conventional network.

Although the noise prediction scheme is described above in the context of filtering, the noise prediction scheme is extendable to noise prediction across other spatial transformations utilizing convolution, including, but not limited to edge enhancement and filtering.

The noise prediction scheme described above provides a method of predicting an output noise variance resulting from spatial filtering and edge enhancement transformations. For a given input image signal with a known input noise variance, a periodic model is developed. A spatial filtering or edge enhancement transformation is performed on the input image signal, and autocovariances at different points in time or lags of the input image signal are also determined. The noise prediction scheme predicts an output noise variance resulting from the spatial filtering or edge enhancement transformation based on the input noise variance, the impulse response of the filter, the autocovariance, and the periodic boundary conditions of the input image signal.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A method of predicting an output noise variance, the method comprising:
a. obtaining an input image signal, wherein the input image signal includes a corresponding input noise having an input noise variance;
b. defining a periodic model associated with the input image signal, wherein the periodic model defines periodic boundary conditions for the input image signal;
c. defining a spatial filtering transformation based on a filter having an impulse response;
d. determining autocovariances at different lags of the input image signal; and
e. determining an output noise variance associated with the input image signal according to the input noise variance, the impulse response of the filter, the autocovariances, and the periodic boundary conditions of the input image signal.

2. The method of claim 1 wherein the spatial filtering transformations include convoluting the input image signal with the impulse response of the filter.

3. The method of claim 1 wherein the input image signal corresponds to an image X comprising a I×J lattice of pixels x(i,j), further wherein the periodic boundary conditions define x(i±I, j±J)=x(i,j).

4. The method of claim 3 wherein defining the spatial filtering transformation includes applying a filter mask to the input image signal.

5. The method of claim 4 wherein the filter mask comprises a M×N rectangular filter mask.

6. The method of claim 5 wherein the output noise variance, r_{y}², is determined according to:
$$\begin{matrix}{r}_{y}^{2} = {r}_{x}^{2} {\sum }_{m = 0}^{M - 1} {\sum }_{n = 0}^{N - 1} {A}_{m , n}^{2} + \\ 2 {\sum }_{k = 1}^{M - 1} {\sum }_{l = 0}^{N - 1} {g}_{xx} ( k , l ) {\sum }_{m = 0}^{M - 1 - k} {\sum }_{n = 0}^{N - 1 - l} {A}_{m , n} {A}_{m + k , n + l} + \\ 2 {\sum }_{k = 0}^{1 - M} {\sum }_{l = 1}^{N - 1} {g}_{xx} ( k , l ) {\sum }_{m = M - 1}^{- k} {\sum }_{n = 0}^{N - 1 - l} {A}_{m , n} {A}_{m + k , n + l}\end{matrix}$$
wherein rₓ² is the input noise variance, gₓₓ(k,1) is the autocovariance of the input signal, and A_{m,n} are weights of an impulse response of the filter mask.

7. The method of claim 6 wherein a number of autocovariances is determined by 2MN−(M+N).

8. The method of claim 6 wherein the input noise is white and the output noise variance, r_{y}², is determined according to:
$${r}_{y}^{2} = {r}_{x}^{2} {\sum }_{m = 0}^{M - 1} {\sum }_{n = 0}^{N - 1} {A}_{m , n}^{2} .$$

9. A method of predicting noise propagation after performing a spatial transformation operation, the method comprising:
a. obtaining an input image signal, wherein the input image signal includes a corresponding input noise having an input noise variance;
b. defining a periodic model associated with the input image signal, wherein the periodic model defines periodic boundary conditions for the input image signal;
c. defining a spatial transformation operation according to a convolution of the input image signal;
d. determining autocovariances at different lags of the input image signal; and
e. determining an output noise variance according to the input noise variance, the autocovariances, and the periodic boundary conditions of the input image signal.

10. The method of claim 9 wherein the spatial transformation operation comprises a non-linear filtering operation.

11. The method of claim 9 wherein the spatial transformation operation comprises a sharpening operation.

12. The method of claim 9 wherein the spatial transformation operation comprises a linear filtering operation.

13. The method of claim 9 wherein performing the spatial filtering transformation includes convoluting the input image signal with an impulse response of a filter.

14. A computer readable medium including program instructions for execution on a controller coupled to an image capturing system, which when executed by the controller, causes the image capturing system to perform:
a. obtaining an input image signal, wherein the input image signal includes a corresponding input noise having an input noise variance;
b. defining a periodic model associated with the input image signal, wherein the periodic model defines periodic boundary conditions for the input image signal;
c. defining a spatial filtering transformation based on a filter having an impulse response;
d. determining autocovariances at different lags of the input image signal; and
e. determining an output noise variance associated with the input image signal according to the input noise variance, the impulse response of the filter, the autocovariances, and the periodic boundary conditions of the input image signal.

15. The computer readable medium of claim 14 wherein the spatial filtering transformations include convoluting the input image signal with the impulse response of the filter.

16. The computer readable medium of claim 14 wherein the input image signal corresponds to an image X comprising a I×J lattice of pixels x(i,j), further wherein the periodic boundary conditions define x(i±I, j±J)=x(i,j).

17. The computer readable medium of claim 16 wherein defining the spatial filtering transformation includes applying a filter mask to the input image signal.

18. The computer readable medium of claim 17 wherein the filter mask comprises a M×N rectangular filter mask.

19. The computer readable medium of claim 18 wherein the output noise variance, r_{y}², is determined according to:
$$\begin{matrix}{r}_{y}^{2} = {r}_{x}^{2} {\sum }_{m = 0}^{M - 1} {\sum }_{n = 0}^{N - 1} {A}_{m , n}^{2} + \\ 2 {\sum }_{k = 1}^{M - 1} {\sum }_{l = 0}^{N - 1} {g}_{xx} ( k , l ) {\sum }_{m = 0}^{M - 1 - k} {\sum }_{n = 0}^{N - 1 - l} {A}_{m , n} {A}_{m + k , n + l} + \\ 2 {\sum }_{k = 0}^{1 - M} {\sum }_{l = 1}^{N - 1} {g}_{xx} ( k , l ) {\sum }_{m = M - 1}^{- k} {\sum }_{n = 0}^{N - 1 - l} {A}_{m , n} {A}_{m + k , n + l}\end{matrix}$$
wherein rₓ² is the input noise variance, gₓₓ(k,1) is the autocovariance of the input signal, and A_{m,n} are weights of an impulse response of the filter mask.

20. The computer readable medium of claim 19 wherein a number of autocovariances is determined by 2MN−(M+N).

21. The computer readable medium of claim 19 wherein the input noise is white and the output noise variance, r_{y}², is determined according to:
$${r}_{y}^{2} = {r}_{x}^{2} {\sum }_{m = 0}^{M - 1} {\sum }_{n = 0}^{N - 1} {A}_{m , n}^{2} .$$

22. An image capturing system comprising:
a. an image sensing module to detect an input image signal, wherein the input image signal includes a corresponding input noise having an input noise variance;
b. a processing module coupled to the image sensing module, wherein the processing module is configured to define a periodic model associated with the input image signal, wherein the periodic model defines periodic boundary conditions for the input image signal, to define a spatial filtering transformation based on a filter having an impulse response, to determine autocovariances at different lags of the input image signal, and to determine an output noise variance associated with the input image signal according to the input noise variance, the impulse response of the filter, the autocovariances, and the periodic boundary conditions of the input image signal.

23. The image capturing system of claim 22 further comprising imaging optics to receive input light from an image, to filter the received input light to form the input image signal, and to provide the input image signal to the image sensing module.

24. The image capturing system of claim 22 wherein the spatial filtering transformations include convoluting the input image signal with the impulse response of the filter.

25. The image capturing system of claim 22 wherein the input image signal corresponds to an image X comprising a I×J lattice of pixels x(i,j), further wherein the periodic boundary conditions define x(i±I, j±J)=x(i,j).

26. The image capturing system of claim 25 wherein the processing module is configured to define the spatial filtering transformation by applying a filter mask to the input image signal.

27. The image capturing system of claim 26 wherein the filter mask comprises a M×N rectangular filter mask.

28. The image capturing system of claim 27 wherein the output noise variance, r_{y}², is determined according to:
$$\begin{matrix}{r}_{y}^{2} = {r}_{x}^{2} {\sum }_{m = 0}^{M - 1} {\sum }_{n = 0}^{N - 1} {A}_{m , n}^{2} + \\ 2 {\sum }_{k = 1}^{M - 1} {\sum }_{l = 0}^{N - 1} {g}_{xx} ( k , l ) {\sum }_{m = 0}^{M - 1 - k} {\sum }_{n = 0}^{N - 1 - l} {A}_{m , n} {A}_{m + k , n + l} + \\ 2 {\sum }_{k = 0}^{1 - M} {\sum }_{l = 1}^{N - 1} {g}_{xx} ( k , l ) {\sum }_{m = M - 1}^{- k} {\sum }_{n = 0}^{N - 1 - l} {A}_{m , n} {A}_{m + k , n + l}\end{matrix}$$
wherein rₓ² is the input noise variance, gₓₓ(k,1) is the autocovariance of the input signal, and A_{m,n} are weights of an impulse response of the filter mask.

29. The image capturing system of claim 28 wherein a number of autocovariances is determined by 2MN−(M+N).

30. The image capturing system of claim 28 wherein the input noise is white and the output noise variance, r_{y}², is determined according to:
$${r}_{y}^{2} = {r}_{x}^{2} {\sum }_{m = 0}^{M - 1} {\sum }_{n = 0}^{N - 1} {A}_{m , n}^{2} .$$
